(19) United States
(12) Patent Application Publication
(10) Pub. No.: US 2005/0189762 A1
(43) Pub. Date: Sep. 1, 2005

(54) Connecting flange for analytical instruments and analytical probe equipped with such a connecting flange

(75) Inventors: Claus Endres, Frankenthal (DE); Ralf Heiseck, Bad Durkheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/002,079

(22) Filed: Dec. 3, 2004

(30) Foreign Application Priority Data
Dec. 8, 2003 (DE) 10357222.8

(51) Int. Cl. F16L 35/00

(52) U.S. Cl. 285/93

(57) ABSTRACT

The invention relates to a connecting flange for analytical instruments for investigating a fluid flowing in a pipeline, having a disk-shaped installation ring (11) which comprises two substantially planar end surfaces (12, 12′), an outer jacket surface (13) and a inner jacket surface (14) which defines an axial passage (15), the installation ring (11) having at least one radial drillhole (16) opening into the outer jacket surface, to which an analytical instrument can be connected. The invention also relates to an analytical probe having such an analytical instrument, and also to the use of this analytical probe in a process for preparing alkyl (meth)acrylates by reacting (meth)acrylic acid with alkanols.

The present invention relates to a connecting flange for analytical instruments for investigating a fluid flowing in a pipeline and to an analytical probe provided with such a connecting flange.

In numerous industrial processes, for example in the chemical industry, in the food industry or in environmental technology, fluids such as liquids or gases are conveyed through frequently very complex pipeline systems. At many points in these pipeline systems, it is necessary, for example for reasons of process monitoring or control, to determine physical or electrochemical parameters of the fluids flowing in the pipelines. Examples include the determination of temperature, pressure, flow rate, pH or spectroscopic investigations.

Pipeline systems are customarily constructed from shorter pipe segments which are joined together via flange connections, for example by means of what are known as preweld flanges. Frequently, owing to change in the processes, modernization of the process control or monitoring, or owing to changed environmental regulations, it is necessary to integrate new analysis points in existing pipeline systems. Since the geometry of the pipeline system is frequently not to be changed, it is customary to remove an existing pipe segment and replace it with a new pipe segment which does correspond to the original pipe segment in the actual course of the line, but additionally has a short T-shaped pipe section which branches off, at whose end flange the particular analytical instrument required, for example a temperature probe or a manometer, is disposed. Such an exchange of the original pipe segment for a specially fabricated analytical pipe segment is associated not only with high production costs, but also analytical disadvantages. One is that the pipe section for the connection of an analytical instrument which branches off always has a certain dead volume which, depending on the analytical parameter investigated, may lead to correspondingly delayed response behavior of the analytical instrument. This makes difficult optimized process monitoring and control.

The technical problem on which the invention is based is to provide an analytical arrangement for determining physical and electrochemical parameters of a fluid flowing in a pipeline, which can be produced inexpensively and installed into already existing pipeline systems without changing the existing construction and with low labor intensity. The novel analytical system should also ensure rapid response of the analytical instruments to changes in the fluid parameters investigated.

This technical problem is solved by providing a novel connecting flange for analytical instruments which has the feature that it can be installed between the connecting flanges of two adjacent pipe segments of a pipeline system.

The invention therefore provides a connecting flange for analytical instruments for investigating a fluid flowing in a pipeline, the analytical flange having a very thin disk-shaped installation ring which comprises two substantially planar end surfaces, an outer jacket surface and an inner jacket surface, the inner jacket surface defining an axial passage of the installation ring which, in the installed state, is substantially collinear to the passages of the connecting flanges of the adjacent pipe segments. The installation ring of the inventive connecting flange also has at least one radial drillhole opening into the outer jacket surface, to which an analytical instrument can be connected externally.

As a consequence of its flat disk-shaped installation ring, the inventive connecting flange can be integrated between any connecting flanges of a pipeline system. This leaves the geometry of the pipeline system virtually unchanged. Its simple construction makes the connecting flange very inexpensive to produce and no existing pipeline segments have to be exchanged. The installation is no more difficult than in the case of an exchange of the seals between the connecting flanges of the pipe segments. Production and installation costs of the inventive connecting flange are typically less than a quarter of the production and installation costs of the conventional exchange pipe segment with analytical flange. It is possible to install the inventive connecting flange very rapidly, since only a sub-branch of the plant has to be temporarily bypassed or shut down, and, unlike the prior system, it is no longer necessary to fully shut down the entire plant. This is because the inventive connecting flange can be installed within a few minutes without welding operations and without extensive modifications. Unlike the earlier technology, there is therefore no risk of sparking, so that it is also unnecessary to take any particular measures for explosion protection. Owing to the localized, tightly restricted intervention into the construction of the plant, the novel connecting flange can typically be installed without scaffolding and without extensive operations on the insulation system of the pipelines which is typically present.

A particular advantage of the invention can also be seen as being that the analytical probe is not welded onto an existing pipe segment. This is because sudden load changes, temperature and pressure variations and similar influences in the course of operation can result in pipe vibrations which, as a consequence of the leverage of the analytical branch, would lead to high stress on such welded joints up to the extent of breaking of welds. In comparison, the installation of the connecting flange by means of flange connections which is envisaged in accordance with the invention is uncritical with respect to the occurrence of pipe vibrations, so that the operational safety of the plant is increased.

The diameter of the axial passage of the installation ring preferably corresponds substantially to the internal diameter of the pipeline, although, depending on the application, for example, slightly larger diameters of the passage of the installation ring may also be preferred. For example, in the case of a nominal diameter (DN) of the pipe of 25 mm, a diameter of the axial passage of the installation ring of 29 mm may be selected, whereas, for example, in the case of a DN 50 pipe, a diameter of the passage of 56 mm may be preferred.

The installation ring of the inventive connecting flange may have, for example, an external diameter which corresponds substantially to the external diameter of the connecting flange of the adjacent pipe segments. In this case, drillholes are provided in the installation ring which enable the connecting screws of the flanges of the pipe segments to be passed through. However, the installation ring more preferably has an external diameter which is smaller than the external diameter of two adjacent connecting flanges of the pipeline between which it is to be installed, so that the installation ring can be designed as a solid ring without disrupting the screw connection of the flanges.

The installation ring of the connecting flange may consist of highly differing materials, especially of those materials which are resistant toward the fluids conducted in the pipeline. The installation ring of the connecting flange preferably consists of stainless steel, for example the material 1.4571 according to DIN 17440 (V4A steel). However, the installation ring may also consist of a less resistant material and be provided on its inner jacket surface with a resistant protection layer, for example a ceramic layer or an enamel layer.

The analytical instrument to be connected may be mounted at the orifice of the outer jacket surface of the installation ring at which the radial drillhole opens into the outer jacket surface. However, since the installation ring preferably has a lower external diameter than the external diameter of the adjacent flanges, the radial drillhole preferably merges into a connecting pipe at the outer jacket surface of the installation ring, said connecting pipe leading, for example, radially outward beyond the edge of the adjacent connecting flanges. The analytical instrument can preferably be connected to this connecting pipe. For this purpose, the connecting pipe may have at its free end, for example, a thread connection or a cutting ring connection. In that case, the installation ring may have a particularly narrow design, so that there is virtually no impairment of the geometry of the pipeline system by the installation of the inventive connecting flange. The axial length of the installation ring, i.e. the length in the flow direction of the fluid, is preferably less than 20 mm, more preferably less than 15 mm and most preferably less than 10 mm.

The design of the radial drillhole of the installation ring is preferably selected depending upon the parameter to be measured. For pressure measurements, it is advantageously provided that the radial drillhole opens into the inner jacket surface of the installation ring, so that the drillhole communicates directly with the axial passage which is flowed through by the fluid to be investigated in the installed state of the connecting flange. For optical investigations, the opening of the radial drillhole may be into the inner jacket surface, but also, for example, sealed by a transparent window, for example a quartz window. The drillhole may also be designed in such a way that a measuring head of the analytical instrument inserted into the drillhole ends flush with the inner jacket surface of the installation ring.

In another variant of the inventive connecting flange, the radial drillhole does not communicate with the axial passage. For example, it may be provided that the radial drillhole opens into a projection which starts from the inner jacket surface of the installation ring and projects into the axial passage. In that case, this projection is flowed around in operation by the fluid to be investigated, so that such an embodiment is particularly suitable, for example, for temperature measurement. To this end, a temperature probe is inserted into the radial drillhole and fed into the projection. In this case, the temperature probe is in contact only with the projection consisting, for example, of stainless steel and does not itself have to consist of a material which is resistant to the fluid to be investigated.

The flanges of the installation ring are preferably designed in accordance with the seal types described in DIN EN 1092-1. Particular preference is given here to the “sealing strip type C” of the standard. However, it is also possible for annular grooves which contain one or more sealing rings to be cut into the planar end surfaces of the installation ring which, in the installed state, are in contact with the connecting flanges of the adjacent pipe segments.

The invention also provides an analytical probe which comprises an analytical instrument which is connected to an inventive connecting flange. In a preferred embodiment, the analytical instrument is a pressure meter, for example a manometer, or a temperature meter. In the case of a temperature meter, the axial length of the installation ring may be particularly low and less than 10 mm, for example approx. 8 mm. In the case of a pressure meter, the preferred axial length of the installation ring is in the range from 10 to 12 mm.

The invention may be used in highly differing industrial chemical processes, for example for preparing plasticizers, solvents, catalysts, amines, diols, carboxylic acids, carboxy and dye intermediates, surfactants, polymers, complexing agents, waxes, biocides, electroplating chemicals, dispersants, concrete plasticizers, automotive chemicals, fuel and lubricant additives, alkylene oxides, glycols, pigments, dyes, coatings and many other products.

However, the inventive connecting flange and the inventive analytical probe provided therewith are used particularly advantageously in processes for preparing alkyl (meth)acrylates by reacting (meth)acrylic acid with alkanols, especially monohydric alkanols having from 1 to 8 carbon atoms. As is known per se, the term (meth)acrylic acid refers to acrylic acid or methacrylic acid. Alkyl esters of (meth)acrylic acid are well known and are significant, for example, as starting monomers for preparing aqueous polymer dispersions which find use, for example, as adhesives. Such a process having further references to the prior art in the preparation of alkyl (meth)acrylates is described, for example, in the patent U.S. Pat. No. 5,883,288 of the applicant. The reactions are typical equilibrium reactions in which the degree of reaction of the (meth)acrylic acid and of the particular alkanol to the corresponding ester is restricted by the equilibrium position. This has the consequence that, for economical process control, firstly the water of esterification has to be removed from the reaction zone to shift the equilibrium in favor of the ester formed, and secondly the unconverted starting materials have to be removed from the ester formed and recycled into the reaction zone. The pure ester is obtained from the reaction mixture conducted out of the reaction zone typically with the aid of a plurality of rectification columns and distillation units. The entire plant consisting of esterification reactor, rectification columns, distillation units, evaporators, condensers, phase separators, pumps, etc., is connected together via numerous draw, reflux and transport lines, in which important process parameters such as pressure and temperature have to be continuously monitored. Since (meth)acrylic acid and its esters are known to tend toward polymerization, there is the risk that dead spaces are formed by the connection lines of analytical instruments and are rapidly blocked by the undesired polymers. Owing to the prevention of dead spaces in the line systems, the use of the inventive connecting flange and the analytical probe provided therewith in such processes is found to be particularly advantageous.

The present invention therefore also provides for a process for preparing alkyl (meth)acrylates by reacting (meth)acrylic acid with alkanols in a plant, said plant comprising at least one pipeline, wherein at least one analytical probe as claimed in one of claims 8 or 9 is used to measure pressure and/or temperature in said at least one pipeline.

The invention is illustrated in detail hereinbelow with reference to an example illustrated in the appended drawing.

In the drawings:

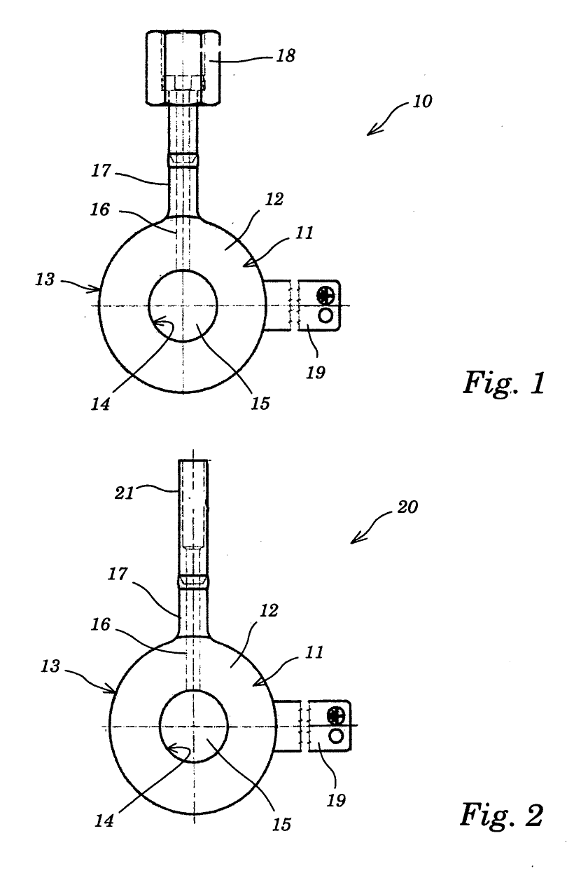

FIG. 1 shows a first embodiment of the inventive connecting flange with penetrating radial drillhole;

FIG. 2 shows a second embodiment of the inventive connecting flange with penetrating radial drillhole;

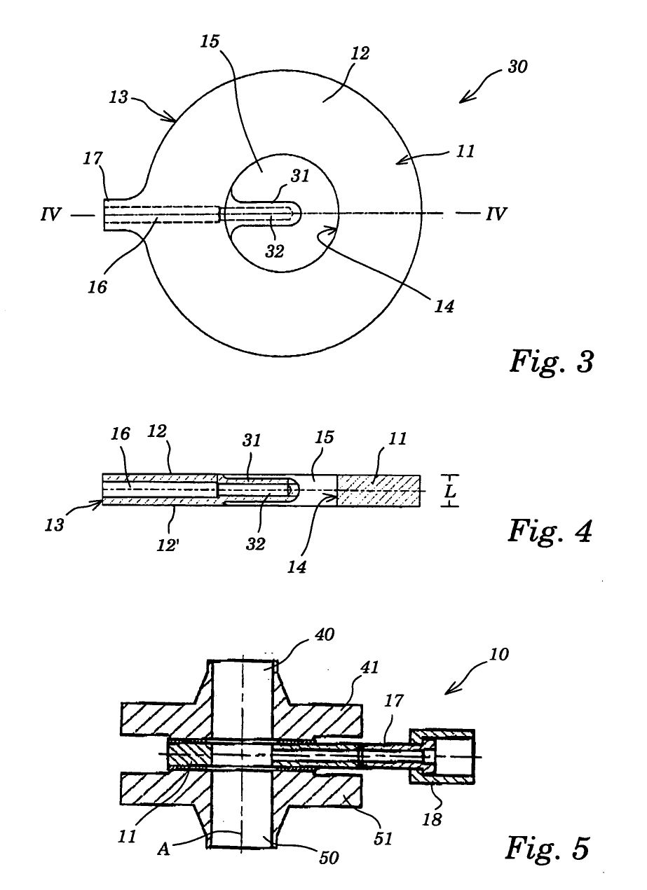

FIG. 3 shows an embodiment of the inventive connecting flange having a projection projecting into the passage;

FIG. 4 shows a section through the connecting flange of FIG. 3 along the line IV-IV;

FIG. 5 shows an inventive connecting flange installed between two connecting flanges of two adjacent pipe segments;

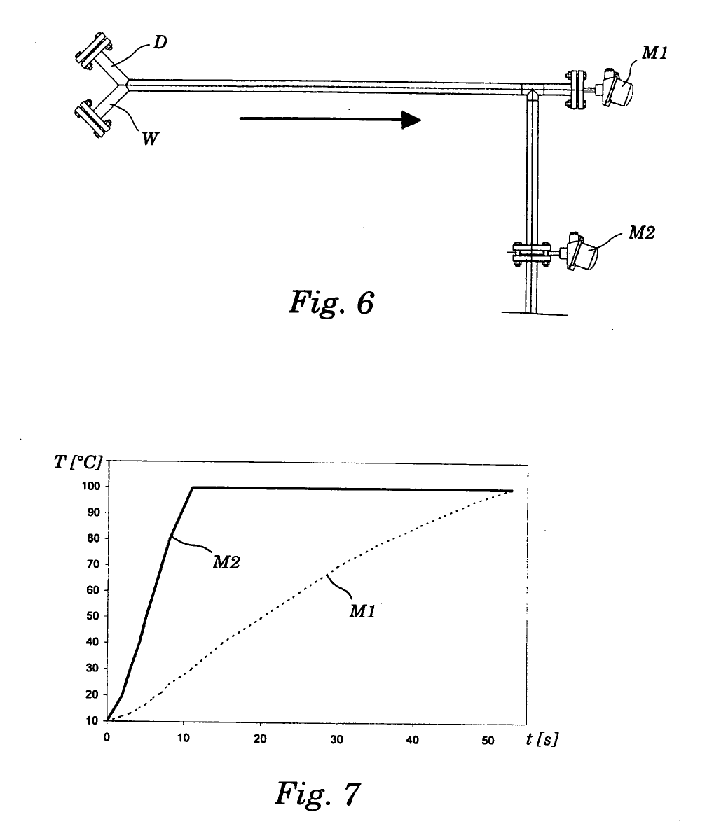

FIG. 6 shows an experimental construction which shows an analytical probe of the prior art and an inventive analytical probe; and

FIG. 7 shows a graph which shows the temperature profile measured with the analytical probes of FIG. 6 after a temperature rise.

With reference to FIG. 1, a first embodiment of the inventive connecting flange for analytical instruments for investigating a fluid flowing in a pipeline can be seen. The connecting flange 10 of FIG. 1 has a disk-shaped installation ring 11 which has a substantially planar end surface 12. The end surface 12′ which is opposite the end surface 12 and cannot be seen in the top view of FIG. 1 (see FIG. 4) is likewise planar. The installation ring 11 has an outer jacket surface 13 and an inner jacket surface 14, and the inner jacket surface 14 borders an axial passage 15 in which the fluid to be investigated flows in the installed state. In the installation ring 11, a drillhole 16 has been drilled and opens into the inner jacket surface 14 in the variants of FIGS. 1 and 2. The radial drillhole 16 merges into a connecting pipe 17 at the outer jacket surface 13, said connecting pipe being provided with a threaded head 18 to connect an analytical instrument which is not shown in FIG. 1. The radial drillhole 16 thus provides a communicating connection from the analytical instrument connected to the threaded head 18 to the axial passage 15 flowed through in operation by the fluid to be investigated. Depending on the requirements, as in the case of the embodiment shown in FIG. 1, a metallic grounding lug 19 may be connected to the installation ring 11 to prevent static charges.

FIG. 2 shows one variant of the connecting flange of FIG. 1, in which structural elements which fulfill the same or a similar function as construction elements of the variant of FIG. 1 are denoted with the same reference numerals. The connecting flange 20 illustrated in FIG. 2 differs from the connecting flange 10 shown in FIG. 1 merely by the formation of the connecting pipe 17 which, in FIG. 2, is provided not with a threaded head, but rather merely with an insertion sleeve 21. The variant of FIG. 2 is also especially suitable for connecting a pressure measuring instrument. However, a fiber-optic probe whose measurement window in the installed state ends flush with the inner jacket surface 14, for example, could also be inserted into the drillhole 16 opening into the passage 15.

FIG. 3 shows an embodiment of the inventive connecting flange which is especially suitable for use as a temperature measuring probe. Construction elements which correspond to the construction elements already described in connection with the embodiment of FIG. 1 are again denoted by the same reference numerals as in FIG. 1. The connecting flange 30 of FIG. 3 differs from the embodiments shown in FIGS. 1 and 2 especially in that the radial drillhole 16 does not open into the inner jacket surface 14 of the installation ring 11. Rather, a projection 31 projecting into the axial passage 15 on the inner jacket surface 14 is provided, and the radial drillhole 16 opens into said projection as a blind drillhole. In such an arrangement, the fluid flowing through the axial passage 15 flows around the projection 31 in operation which rapidly assumes the temperature of the fluid. This variant is therefore especially suitable for temperature measurement, in which case a temperature probe can be inserted into the radial drillhole 16 and is in thermal contact with the projection 31 in the lower region 32 of the radial drillhole 16.

FIG. 4 shows a section along the line IV-IV of FIG. 3. The axial length L of the installation ring selected is as narrow as possible, so that there is virtually no change in the geometry of the pipeline system as a result of the installation of the inventive connecting flange.

FIG. 5 finally shows a schematic of the connecting flange 10 of FIG. 1 in the installed state. In FIG. 5, two adjacent pipeline segments 40, 50 which are joined together by connecting flanges 41, 51 can be seen. Between the connecting flanges 41, 51 is installed the inventive connecting flange 10. The minimum axial expansion of the installation ring 11 of the connecting flange 10 results in the original geometry of the pipeline system being virtually unchanged by the installation of the connecting flange.

FIG. 6 shows a schematic experimental construction in which the temperature of a fluid flowing in a pipeline is determined using temperature probes M1 and M2. According to the prior art, the temperature probe M1 is flanged onto a T-shaped analysis tube which branches off, while the temperature probe M2 is mounted between the flanges of two pipe segments via an inventive connecting flange (cf. FIG. 3). Feed lines can be used to conduct either water W having a temperature of 10° C. or steam D having a temperature of 100° C. into the pipeline. The temperature sensors used are in each case TR01 transducer heads from Sensycon which are supplied by CSOC 420 feed units from Hartmann & Braun.

FIG. 7 shows a graph in which the development with time of the temperatures measured at the measurement points M1 and M2 of FIG. 6 after a change from water to steam is shown. It can be seen that the inventive arrangement (curve M2) responds substantially more rapidly to temperature changes, while only delayed response behavior is registered at the measurement point M1 in accordance with the prior art as a consequence of the dead volume in the tube section branching off to the measurement point.

1. A connecting flange for analytical instruments for investigating a fluid flowing in a pipeline, having a disk-shaped installation ring which comprises two substantially planar end surfaces, an outer jacket surface and an inner jacket surface which defines an axial passage, the installation ring having at least one radial drillhole opening into the outer jacket surface, to which an analytical instrument can be connected.

2. The connecting flange according to claim 1, wherein the diameter of the axial passage of the installation ring corresponds substantially to the internal diameter of the pipeline.

3. The connecting flange according to claim 1, wherein the installation ring has an external diameter which is smaller than the external diameter of the two connecting flanges of the adjacent pipeline segments between which the installation ring can be installed.

4. The connecting flange according to claim 1, wherein the radial drillhole merges into a connecting pipe at the outer jacket surface of the installation ring.

5. The connecting flange according to claim 4, wherein the analytical instrument can be connected to the connecting pipe.

6. The connecting flange according to claim 1, wherein the radial drillhole opens into the inner jacket surface of the installation ring.

7. The connecting flange according to claim 1, wherein the radial drillhole opens into a projection which starts from the inner jacket surface of the installation ring and projects into the axial passage.

8. The connecting flange according to claim 1, wherein the axial length of the installation ring is less than 20 mm, preferably less than 15 mm and more preferably less than 10 mm.

9. An analytical probe having an analytical instrument which is connected to a connecting flange as claimed in any of claims 1 to 8.

10. The analytical probe as claimed in claim 9, in which the analytical instrument is a pressure meter or a temperature meter.

11. A process for preparing alkyl (meth)acrylates by reacting (meth)acrylic acid with alkanols in a plant, said plant comprising at least one pipeline, wherein at least one analytical probe as claimed in one of claims 8 or 9 is used to measure pressure and/or temperature in said at least one pipeline.
